(19) United States
(12) Patent Application Publication
(10) Pub. No.: US 2019/0321779 A1
(43) Pub. Date: Oct. 24, 2019

(54) BIOWALL SYSTEMS AND METHODS FOR POLLUTANT PROCESSING

(71) Applicants: Michael FURBISH, Pasadena, MD (US); UNIVERSITY OF MARYLAND, COLLEGE PARK, College Park, MD (US)

(72) Inventors: Andrew George RISTVEY, Queen Anne, MD (US); Steven M. COHAN, Westlake Village, CA (US); Erica BROWN, Millersville, MD (US); Michelle STANLEY, Reisterstown, MD (US); Nicole PALUMBO, Bridgewater, NJ (US); Morgan SULZBACH, Bel Air, MD (US); Gabrielle ENGUILLADO, Fort Washington, MD (US); Jaclyn TAYLOR, Boulder, CO (US); Jill SMITH, Bel Air, MD (US); Michael FURBISH, Pasadena, MD (US)

(21) Appl. No.: 16/389,251

(22) Filed: Apr. 19, 2019

Related U.S. Application Data
(60) Provisional application No. 62/660,620, filed on Apr. 20, 2018.

(51) Int. Cl. B01D 53/73; A01G 31/02; A01G 29/00; B01D 53/46

(52) U.S. Cl. CPC B01D 53/73; B01D 53/46; A01G 29/00; A01G 31/02

(57) ABSTRACT

A biowall has a support structure, an irrigation system, and a dissolution system. The support structure holds a plurality of plants thereon. The dissolution system dissolves pollutants from air into solution. Using the irrigation system, the solution with dissolved pollutants therein can then be supplied to roots of one or more plants supported by the biowall support structure. At least a portion of the dissolved pollutants supplied to the roots can be metabolized, for example, by bacteria at the roots of the plants. For example, the pollutants can include volatile organic compounds (VOCs). In some embodiments, the biowall can be constructed as a self-supporting, stand-alone unit.

### CROSS-REFERENCE TO RELATED APPLICATIONS

The present application claims the benefit of U.S. Provisional Application No. 62/660,620, filed Apr. 20, 2018, which is hereby incorporated by reference herein in its entirety.

### FIELD

The present disclosure relates generally to biowalls, and more particularly, to systems and methods for pollutant processing using a biowall.

### BACKGROUND

Biowalls, also known as green walls or green facades, are systems of vegetation grown on a vertical or substantially-vertical plane, for example, a building's exterior surface, an internal wall or support structure of the building, or a separate structural system. In general, biowalls can be categorized as either active or passive. With active biowalls, the system is integrated with the heating, ventilation, and air conditioning (HVAC) systems of the building, for example, to allow building air to be passed through the vegetation of the biowall for filtration purposes. In contrast, passive biowalls are not integrated with building HVAC systems and instead rely on the natural flow of air contacting the exposed foliage (i.e., shoot system) of the vegetation to provide filtration. The integration with building HVAC systems can allow active biowalls to provide greater filtration, albeit at the expense of increased manufacturing and operating costs as compared to passive systems. Moreover, the passage of air through the root system of the vegetation in active biowalls can stress the vegetation and/or require additional hydration to maintain the vegetation in a healthy state.

Embodiments of the disclosed subject matter may address the above-mentioned problems and limitations, among other things.

### SUMMARY

Embodiments of the disclosed subject matter provide systems and associated methods that provide filtration of air by dissolving pollutants from the air in solution (e.g., water) prior to providing the solution directly to roots of vegetation of a biowall for processing. The system can be provided within a building or other inhabitable structure to ameliorate indoor air quality by removing pollutants therefrom. In particular, the plant roots and/or bacteria colonies at the plant roots can metabolize the pollutants in solution. Such pollutants can include, but are not limited to, volatile organic compounds (VOCs).

In one or more embodiments, a method comprises dissolving one or more pollutants from air in an environment into a solution. The solution with dissolved pollutants can then be supplied to roots of one or more plants supported by a biowall. The method can further comprise metabolizing at least a portion of the dissolved pollutants supplied to the roots.

In one or more embodiments, the biowall comprises a support structure, an irrigation system, and a dissolution system. The support structure can be constructed to hold a plurality of plants thereon. The irrigation system can be constructed to supply a solution to roots of the plants held by the support structure. The dissolution system can be constructed to dissolve one or more pollutants from air into the solution.

Objects and advantages of embodiments of the disclosed subject matter will become apparent from the following description when considered in conjunction with the accompanying drawings.

### BRIEF DESCRIPTION OF DRAWINGS

Embodiments will hereinafter be described with reference to the accompanying drawings, which have not necessarily been drawn to scale. Where applicable, some elements may be simplified or otherwise not illustrated in order to assist in the illustration and description of underlying features. Throughout the figures, like reference numerals denote like elements.

FIG. 1 is a simplified schematic diagram of aspects of a biowall system for pollutant processing, according to one or more embodiments of the disclosed subject matter.

FIG. 2 is a process flow diagram of a method for pollutant processing using the biowall system, according to one or more embodiments of the disclosed subject matter.

FIG. 3A is a simplified cross-sectional view of a panel-based biowall employing a hydroponic irrigation system, according to one or more embodiments of the disclosed subject matter.

FIG. 3B is a simplified cross-sectional view of a felt-based biowall employing a hydroponic irrigation system, according to one or more embodiments of the disclosed subject matter.

FIG. 3C is a simplified cross-sectional view of a container-based biowall employing a hydroponic irrigation system, according to one or more embodiments of the disclosed subject matter.

FIG. 3D is a simplified cross-sectional view of a biowall employing an aeroponic irrigation system, according to one or more embodiments of the disclosed subject matter.

FIG. 4 is a simplified schematic diagram of aspects of an exemplary dissolution system, according to one or more embodiments of the disclosed subject matter.

FIGS. 5A-5C are isometric views of an exemplary design for a biowall system for pollutant processing.

FIGS. 5D-5E are side and rear views, respectively, of the biowall system of FIGS. 5A-5C.

FIG. 5F is a front view illustrating an exemplary planting layout for the biowall system of FIGS. 5A-5E.

### DETAILED DESCRIPTION

Embodiments of the disclosed subject matter relate to filtration of pollutants from air in an environment using a biowall supporting a plurality of plants (i.e., vegetation) thereon. Pollutants from the environment in which the biowall is installed, or from elsewhere, are actively dissolved in solution (e.g., water), which is then supplied to roots of the vegetation supported by the biowall. At the roots, the dissolved pollutants are metabolized, thereby removing the pollutants from the environment. In some embodiments, the pollutants are metabolized by bacteria colonies at the plant roots, and the resulting metabolites can be used by the vegetation and/or by the bacteria colonies for sustenance or growth (i.e., as a carbon or energy source).

As used herein, pollutants refer to any water-soluble air-borne chemical in the environment that may be harmful or otherwise considered undesirable. For example, in some embodiments, the pollutants are indoor-atmospheric volatile organic compounds (VOCs), such as, but not limited to, formaldehyde, benzene, xylene, toluene, ethylbenzene, and polycyclic aromatic hydrocarbons (e.g., naphthalene, benzo(a)pyrene, etc.). Such pollutants, once dissolved in solution, can be metabolized by bacteria at the plant roots. When the pollutants are VOCs, the bacteria can be from the Hyphomicrobium genus or Pseudomonas genus, for example, Hyphomicrobium spp., such as Hyphomicrobium denitrificans, or Pseudomonas putida G7. When plant roots are exposed to the dissolved VOCs, bacteria (which may be naturally occurring or artificially seeded on the plant roots) can proliferate by virtue of their metabolism of the VOCs. The pollutants and metabolizing bacteria can thus exhibit a symbiotic relationship, whereby the population of bacteria at the roots may increase to process higher level of the pollutants and may decrease once levels have been mitigated.

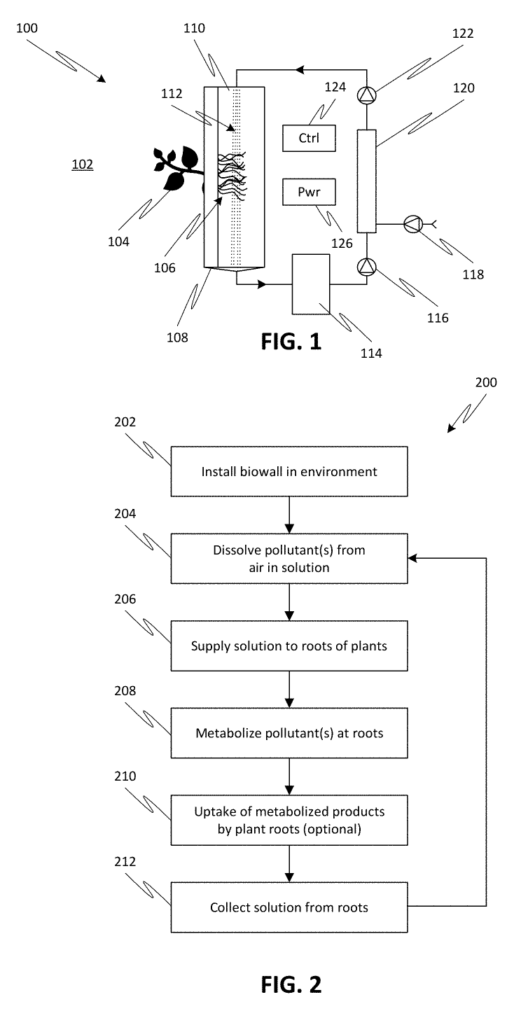

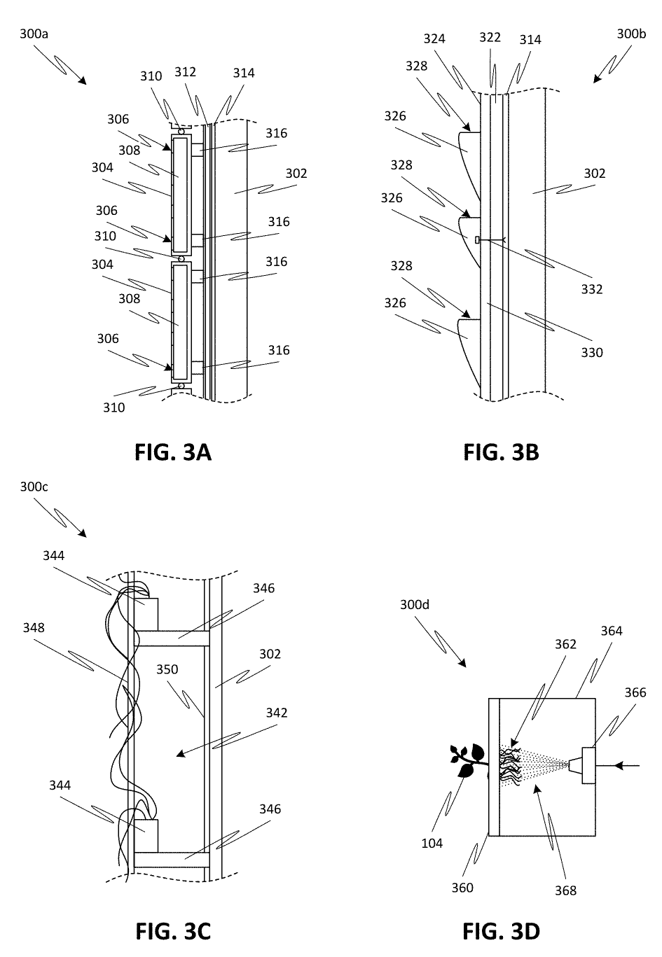

Referring to FIGS. 1-2, aspects of a generalized biowall system 100 and method 200 for pollutant processing are illustrated. At 202 of method 200, the biowall system 100 can be installed in an environment 102. For example, the environment 102 can be the inside of a building (e.g., room) or other inhabitable structure (e.g., natural enclosure, vehicle, etc.). In some embodiments, the biowall system 100 can be constructed as a self-supporting, standalone (i.e., free-standing) unit. Thus, support structure 108 may be placed within environment 102 without relying on a separate existing structure (e.g., a wall of a building) for support. Alternatively, the biowall system 100 can be attached to a separate existing structure (e.g., a wall of a building) for support and/or coupled to air-handling components in the environment (e.g., to receive air via pump 118 from an HVAC system). In either case, the installation of the biowall system 100 may be temporary or permanent. In such temporary installations, the biowall system 100 may be sized and constructed so as to be portable.

The biowall system 100 can include at least a support structure 108, an irrigation system, and a dissolution system, among other components. The support structure 108 is constructed to support one or more plants thereon, with the shoot system 104 of each plant being separated from the root system 106 by the support structure 108. In particular, the shoot system 104 of the plant can be positioned outward toward the environment 102, so as to receive light and/or air from the environment and to provide an aesthetically pleasing external face for the biowall system 100. The root system 106 can be held within a growth medium (or irrigation space) 110, which may also be supported by or at least coupled to the support structure 108. Water 112 (including any nutrients and dissolved pollutants) can thus be provided directly to the roots 106 via growth medium 110.

At 204 in method 200, pollutants are dissolved in solution (e.g., water), for example, by the dissolution system of biowall system 100. In particular, the dissolution system of biowall system 100 includes a fluid column 120 where air (e.g., via air pump 118) is injected into the water in order to dissolve the air, including any pollutants therein, into the water. Any air not dissolved by injection in column 120 can be captured (e.g., at an opposite end of the column 120) and recirculated via air pump 118 to encourage dissolution. The air pump 118 can have an inlet within environment 102, such that the polluted air from the environment 102 is dissolved in the water in column 120. Alternatively, the air pump 118 can take air from a different environment (e.g., via an air conduit or HVAC outlet) or from an air reservoir (e.g., polluted air previously captured in a container).

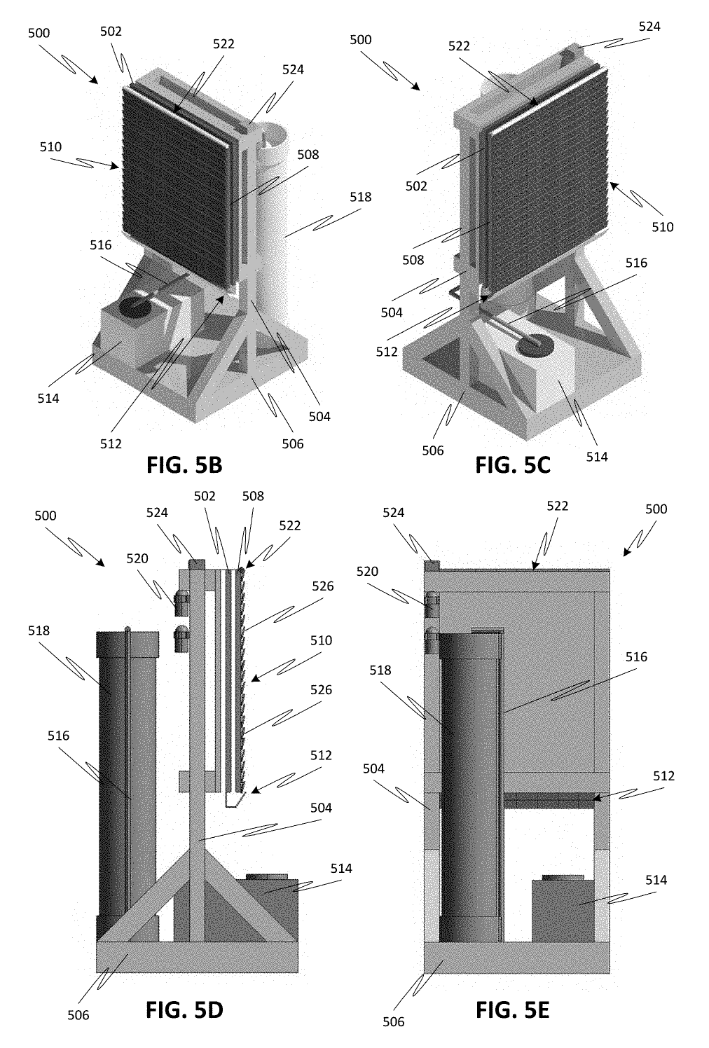

For example, the dissolution system can comprise an aerator, such as a jet aerator, a coarse bubble aerator, or a fine bubble aerator. In some embodiments, the dissolution system can be a gas-absorption bubbling fluid column 120, for example, as illustrated with respect to FIG. 4. Air inlet 404 can receive air with pollutants therein, which air is passed through a porous material or membrane 406 to generate small bubbles 410 within water 408 held by column 402. The bubbling increases the surface contact area with the water 408, thereby decreasing the time necessary for diffusion of the pollutants into the water 408. Water with dissolved pollutants 414 can be removed via fluid outlet 412 for use in irrigating plant roots. In some embodiments, air that does not dissolve in the water 408 can be recirculated, for example, by collecting at the top of column 402 and returning to air inlet 404.

Although a particular configuration has been illustrated in FIG. 4, other configurations are also possible. For example, fluid outlet 412 may be positioned at a bottom of column 402 along with the air inlet 404, while a fluid inlet (not shown) may be positioned at a top of column 402 along with an air outlet (not shown). Moreover, other methodologies for dissolving air in the water prior to delivery to the root system 106 are also possible for the dissolution system, such as, but not limited to, tray column gas absorption systems, packed column gas absorption systems, spray column gas absorption systems, and co-current gas absorption systems.

Returning to FIGS. 1-2, the amount of pollutants capable of being dissolved in the water by the dissolution system may be dependent upon the initial concentration of the pollutants in the air as well as the solubility of the pollutant in water. Larger pollutant concentrations yield a higher driving force for diffusion into the water. But as the concentrations approach equilibrium, the net driving force decreases until no further diffusion occurs, in essence reaching a maximum pollutant concentration in the water and a minimum pollutant concentration in the air. This equilibrium point is related to interaction between the water and pollutant and may be influenced by vapor-liquid equilibrium ratios for each chemical.

After 204, the method 200 can proceed to 206, where water with pollutants dissolved therein is supplied to the root system 106, for example, by the irrigation system of biowall system 100. The irrigation system can deliver water 112 from a reservoir 114 to the root system 106. Any water not used by the root system 106 (i.e., via respiration) or otherwise lost to the environment 102 (e.g., via transpiration or evaporation) can be captured by the irrigation system and returned to the reservoir 114 for reuse (e.g., at 212 of method 200). The irrigation system can include one or more conduits connecting the reservoir 114 to inlet and outlet ends of the growth medium 110 and/or support structure 108, as well as one or more pumps 116, 120 for moving water within the conduits.

Although shown separately in FIG. 1, it is also possible that components of the irrigation and dissolution systems can be combined together, according to one or more contemplated embodiments. For example, in some embodiments, the reservoir 114 can act as both reservoir and fluid column. In such an example, air pump 118 would provide air input to reservoir 114, and column 120 and second fluid pump 122 would be omitted.

The biowall system 100 can also include an optional power supply 126 that provides electrical power to pumps 116, 118, 122 as well as other components of the system 100. For example, power supply 126 can be an on-board battery (e.g., a primary battery or secondary battery rechargeable by an external electrical power source or on-board solar panel) or a transformer that converts external electrical power (e.g., from a building outlet) for use by the components of system 100.

The biowall system 100 can also include an optional controller 124, which controls operation of the various components of the system. For example, the controller 124 can regulate operation of pumps 116, 122 to provide desirable irrigation to the root system 106 and may receive feedback from one or more sensors that provide an indication of, for example, plant health or irrigation conditions. The controller 124 can also regulate operation of air pump 118, for example, to provide sufficient dissolution conditions based on a flow rate of water through column 120.

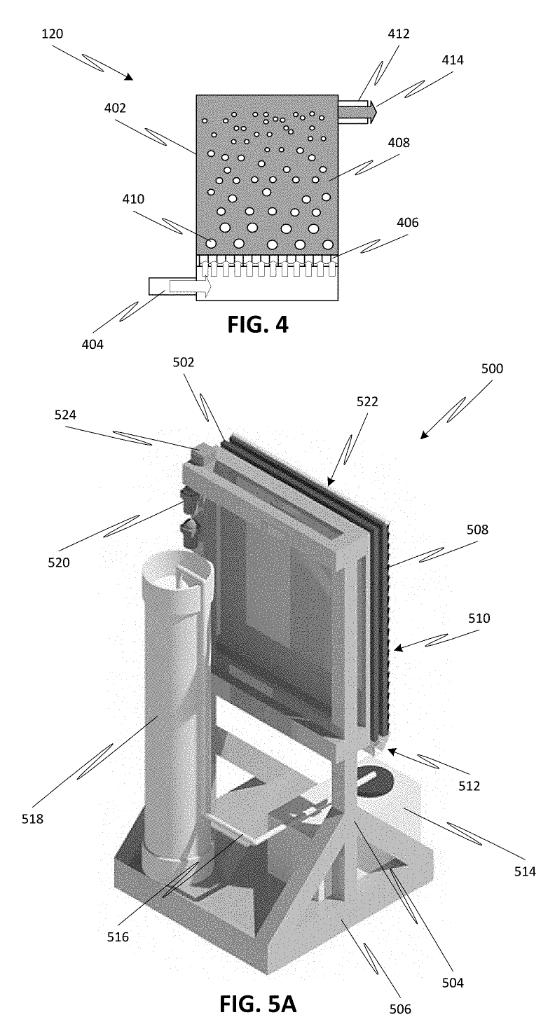

At 206 of method 200, supply of water to roots 106 within medium/space 110 can be via hydroponic or aeroponic techniques, whereby water with the dissolved pollutants therein is directly supplied to the root system 106. In a hydroponic technique, the irrigation system may rely on gravity and/or capillary effects to provide final delivery of water to the root system 106 (see, for example, FIGS. 3A-3C). In an aeroponic technique, the irrigation system may mist or atomize the water to provide final delivery of water to the root system 106 (see, for example, FIG. 3D). In either technique, the pollutants are provided to the roots dissolved in water rather than being delivered to the roots via an air flow.

At 208 in method 200, at least some of the dissolved pollutants provided to the root system 106 are metabolized. As noted above, the dissolved pollutants can be metabolized by bacteria colonies (i.e., bioremediation), e.g., bacteria from the Hyphomicrobium or Pseudomonas genera, and the resulting metabolites can be used by the bacteria colonies and/or optionally by the vegetation at 210 for sustenance or growth (i.e., as a carbon or energy source). Such bacteria colonies may occur naturally on the plant roots or be artificially seeded onto the plant roots (e.g., during the installation of vegetation on the biowall). Alternatively or additionally, the plant roots may directly metabolize the dissolved pollutants at 208 (i.e., phytoremediation).

In some embodiments, the roots of the vegetation may be seeded with one or more bacteria colonies specifically selected to metabolize a pollutant known to be present in the environment. For example, when the pollutant is a polycyclic aromatic hydrocarbon (PAH), the seeded bacteria may be selected from the Pseudomonas genus. In a particular example, when the PAH comprises naphthalene, bacteria such as Pseudomonas putida G7 (PpG7) can be seeded onto the roots to metabolize the dissolved pollutant. The seeding of bacteria colonies other than those specifically described herein in order to metabolize other types of dissolved pollutants is also possible according to one or more contemplated embodiments. Once the pollutant supply from the environment has been exhausted (i.e., all or substantially all of the pollutant has been removed from the environment and metabolized by the bacteria colonies), the seeded bacteria colonies may naturally terminate.

As noted above, an initial equilibrium concentration for the pollutants in water is achieved at 204 prior to supply to the roots. However, the subsequent supply 206 and metabolizing 208 removes at least a portion of the pollutants from the water, which is then recycled back to 204 via process step 212, thereby creating a new equilibrium point for more pollutant dissolution. The method 200 may repeat steps 204-212 to effect a continuous or semi-continuous cycle for processing pollutants from air in an environment 102, until all or substantially all of one or more pollutants are removed from the air.

Thus, although steps 204-212 are illustrated separately in FIG. 2, it is contemplated that such process steps may occur contemporaneously, for example, during the continuous operation of the biowall system. Moreover, the particular order of steps 204-212 in FIG. 2 has been chosen for explanatory purposes only and is not intended to be limiting. Indeed, in practical embodiments of the disclosed subject matter, the illustrated steps may occur before or during other steps. For example, the supplying solution of 206 may be considered to occur before or during the pollutant dissolution of 204.

The concepts of the biowall system 100 and method 200 can be applied to various biowall constructions and irrigation techniques. For example, FIG. 3A illustrates a biowall 300a employing a panel-based support system and hydroponic irrigation that can be adapted to include a dissolution system for pollutant processing. The biowall system 300a can include one or more panels 304 housing a growth media 308 therein. A front surface of each panel 304 can include one or more perforations 306, through which the root system of a plant can be inserted into the growth medium 308. Each panel 304 can be coupled to a common vertical support 312 (e.g., stainless steel panel) by respective horizontal supports 316 (e.g., stainless steel purlins). The vertical support 312 can be coupled to a supporting structure 302 (e.g., building wall) via a waterproof or protective covering 314, or can otherwise be self-supporting (e.g., via a base, not shown).

An irrigation line 310 (e.g., drip line) can be provided between vertically-adjacent pairs of panels 304 to provide water, with dissolved pollutants therein, to the growth media 308 underneath and thereby to the roots of the plants supported by the panels 304. As such, the irrigation system may rely at least on gravity, and perhaps even capillary action within growth media 308, to distribute the water with dissolved pollutants from irrigation line 310 to the root system. Water runoff can be collected via a trough or basin at a bottom of the biowall 300a for re-dissolution of pollutants by the dissolution system and subsequent recirculation by the irrigation system.

In another example illustrated in FIG. 3B, a biowall 300b employs a felt-based support system and hydroponic irrigation that can be adapted to include a dissolution system for pollutant processing. The biowall system 300b can include one or more pockets 326 that form respective cavities 328 for holding plants therein, with root systems growing into growth medium 330 of felt layer 324. The felt layer 324 can be held to a more rigid backing layer 322 by one or more attachment devices 332 (e.g., ties, screws, clips, staples, rivet, etc.) The backing layer 322 can be coupled to a supporting structure 302 (e.g., building wall) via a waterproof or protective covering 314, or can otherwise be self-supporting (e.g., via a base, not shown).

An irrigation line (not shown) can be provided at an upper end of felt layer 324 to provide water, with dissolved pollutants therein, to the growth media 330 underneath and thereby to the roots of the plants supported in pockets 326. As such, the irrigation system may rely at least on gravity and/or capillary action within growth media 330, to distribute the water with dissolved pollutants from irrigation line to the root system. Alternatively, the irrigation system can flow water through a layer of channels provided behind and adjacent to felt layer 324 (e.g., within backing layer 322 or between backing layer 322 and felt layer 324). The growth medium 330 is thus kept moist by the continuous flow of water through such channels. In either case, water runoff and/or water exiting the channel layer can be collected for re-dissolution of pollutants by the dissolution system and subsequent recirculation by the irrigation system.

In yet another example illustrated in FIG. 3C, a biowall 300c employs a container-based support system and hydroponic irrigation that can be adapted to include a dissolution system for pollutant processing. The biowall system 300c can include one or more containers 344 that hold the roots of plants therein. Each container 344 can be coupled to a vertically-extending support structure 302 (e.g., building wall) by respective horizontal supports 346. Alternatively, the support structure 302 may be a free-standing, self-supporting structure (e.g., via a base, not shown) rather than a wall of a building.

A vertically-extending trellis 348 can be provided adjacent to containers 344 to provide support to the shoot systems of the growing plants. An access space 342 can thus be defined between the plant-covered trellis 348 and an external finish 350 of support 302. Respective irrigation lines (not shown) can provide water, with dissolved pollutants therein, to the roots of the plants supported in containers 344. For example, components of the irrigation and/or dissolution systems may be disposed within access space 342 (but blocked from view by plant growth on trellis 348) or on a side of support 302 opposite from access space 342. Water runoff and/or excess water exiting the containers 344 can be collected for re-dissolution of pollutants by the dissolution system and subsequent recirculation by the irrigation system.

In still another example illustrated in FIG. 3D, a biowall 300d employs aeroponic irrigation that can be adapted to include a dissolution system for pollutant processing. The biowall system 300d can include a support structure 360 that holds one or more plants 104. In particular, the support structure 360 isolates the root system 362 from the rest of the plant 104, with the roots 362 being suspended in air in an enclosure 364. Water with pollutants dissolved therein is directed to an inlet of mister or atomizer 366, which generates a mist 368 directed at the root system 362. The mist 368 of water with dissolved pollutants thus travels through air without an intervening growth medium to thereby envelope and hydrate the root system 362. Such misting can be continuous or intermittent, depending on the needs of the plants.

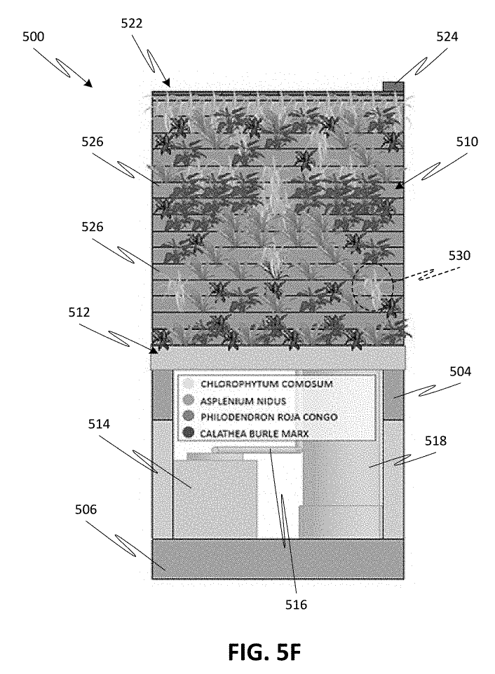

Turning to FIGS. 5A-5F, a fabricated biowall system 500 employing a felt-based support system and hydroponic irrigation is shown. The biowall 500 has a rectangular plant support panel 502. The support panel 502 is formed of polyvinyl chloride (PVC) panel board. The PVC panel has dimensions of 1.3 m×1.3 m×2 cm. The support panel 502 is coupled to a frame 504 with a base 506, thereby creating a self-supporting structure. The frame 502 and base 506 provides a footprint for the device of 2 m×1.3 m×0.9 m (H×W×D) and is formed of wood. A capillary fiber layer 508 is disposed on one surface of the plant support panel 502. The capillary fiber layer 508 is covered by individual felt strips 526 to form a face 510 of horizontally-extending pockets that hold one or more plants therein. In particular, fifteen strips 526 of felt, having dimensions of 4 cm×1.3 m and overlapping by 1cm in the vertical direction, are attached over the capillary fiber layer 508. The locations of plants 530 supported by felt strips 526 on the biowall 500 is illustrated in FIG. 5F. Once established, the roots of the plants grow through the felt media and capillary fiber layer 508.

The capillary fiber layer 508 is used to deliver water to roots of the plants 530 via gravity and capillary action. At the base of panel 502 is a basin 512 for capturing run-off from the plants 530 and capillary fiber layer 508. The basin 512 is connected via a fluid conduit to a solution reservoir 514 (e.g., 75.7 L polycarbonate storage tank). Nutrients can also be added to the reservoir 514, such that the solution circulated by the biowall system 500 is not pure water. For example, a 15-5-15 N-P₂O₅-K₂O fertilizer was added to the water in reservoir 514 to provide nutrients to the roots of the plants.

To dissolve pollutants in the water, a gas absorption bubbling water column 518 (e.g., 20 cm ID×1.7 m PVC column) is coupled to the reservoir 514 by a fluid conduit 516. A sump pump (not shown) moves water from the reservoir 514 to the column 518, where air from the environment (including one or more pollutants) is bubbled into the water in the column via air pump 524. A diaphragm water pump 520 then moves water, with dissolved pollutants therein, from the column 518 to roots of the plants on face 510 via irrigation manifold/emitters 522 at the top of panel 502.

The irrigation manifold/emitters 522 includes a horizontally-extending tubing (e.g., 1.27 cm ID PVC) with eight drip emitters (e.g., Netafim emitters, spaced 15.24 cm apart from each other along the tubing). Water with dissolved pollutants exits manifold/emitters 522 at a top of panel 502 and reaches roots of the supported plants 530 via capillary fiber layer 508 by virtue of capillary action and gravity. Any water that reaches the bottom of the panel is then collected by basin 512 for reprocessing. As a result, the biowall system 500 is able to extract pollutants from the environment (i.e., via air pump 524), dissolve the pollutants in water (i.e., via column 518), and then process the dissolved pollutants (i.e., via bacteria colonies at the roots of plants 530) in order to filter pollutants from the air in the environment.

Embodiments of the disclosed biowall systems and methods can thus be used to eliminate, or at least reduce, airborne pollutants in an environment. For example, the disclosed biowalls can be used in the interior of new buildings or building renovations, where construction materials may off-gas pollutants such as VOCs. In some embodiments, the biowalls can be installed temporarily, for example, until pollutant concentrations reach a suitable level or the pollutants are eliminated. Such biowalls may be constructed as portable, modular systems (e.g., self-supporting, stand-alone units, although power may be derived from a building in which the biowall is installed).

Alternatively, the biowall can be part of a more permanent installation or can be integrated with components of the building. For example, an air outlet of a building HVAC can be coupled to an inlet of the dissolution system of the disclosed biowalls. However, unlike some conventional biowall systems, the disclosed biowalls do not require integration with building HVAC systems and thus may be cheaper to manufacture and operate. Moreover, since the disclosed biowalls do not require exposing the roots to airflow in order to deliver pollutants as with some conventional biowall systems, unnecessary stressing of the plants can be avoided and overall plant health can be improved.

One of ordinary skill in the art will readily appreciate that the above description is not exhaustive, and that aspects of the disclosed subject matter may be implemented other than as specifically disclosed above. Although exemplary chemistries, materials, and dimensions have been discussed above, one of ordinary skill in the art will understand that the teachings of the present disclosure can be extended to other materials, chemistries, and dimensions. Thus, embodiments of the disclosed subject matter are not limited to the specific chemistries, materials, and dimensions discussed herein.

It will be appreciated that some aspects of the disclosed subject matter can be implemented, fully or partially, in hardware, hardware programmed by software, software instruction stored on a computer readable medium (e.g., a non-transitory computer readable medium), or any combination of the above. For example, components of the disclosed subject matter, including components such as a controller, method, or any other feature, can include, but are not limited to, a personal computer or workstation or other such computing system that includes a processor, microprocessor, microcontroller device, or is comprised of control logic including integrated circuits such as, for example, an application specific integrated circuit (ASIC).

The terms “front,” “top,” “bottom,” “side,” “horizontal,” and “vertical” have been used herein to describe the relative locations of different components of the disclosed embodiments. However, the embodiments are not limited to specific directions or orientations. Where such descriptive terms are used, they are to include deviations therefrom. For example, “horizontal” can include directions that have a minor vertical component (e.g., up to 10%) and “vertical” can include directions that have a minor horizontal component (e.g., up to 10%). Moreover, the above terms have been used herein for convenience and are not intended to limit an arrangement of the biowall with respect to gravity. Indeed, it is contemplated that in some embodiments of the disclosed subject matter, the vertical direction may extend perpendicular to (or may have a component that extends perpendicular to) the direction of gravity and the horizontal direction may extend parallel to (or may have a component that extends parallel to) the direction of gravity.

In this application, unless specifically stated otherwise, the use of the singular includes the plural, and the separate use of “or” and “and” includes the other, i.e., “and/or.” Furthermore, use of the terms “including” or “having,” as well as other forms such as “includes,” “included,” “has,” or “had,” are intended to have the same effect as “comprising” and thus should not be understood as limiting.

Any range described herein will be understood to include the endpoints and all values between the endpoints. Whenever “substantially,” “approximately,” “essentially,” “near,” or similar language is used in combination with a specific value, variations up to and including 10% of that value are intended, unless explicitly stated otherwise.

It is thus apparent that there is provided, in accordance with the present disclosure, biowall systems and methods for pollutant processing. Many alternatives, modifications, and variations are enabled by the present disclosure. While specific examples have been shown and described in detail to illustrate the application of the principles of the present invention, it will be understood that the invention may be embodied otherwise without departing from such principles. For example, disclosed features may be combined, rearranged, omitted, etc. to produce additional embodiments, while certain disclosed features may sometimes be used to advantage without a corresponding use of other features. Accordingly, Applicant intends to embrace all such alternative, modifications, equivalents, and variations that are within the spirit and scope of the present invention.

1. A method comprising:
dissolving one or more pollutants from air in an environment into a solution;
supplying the solution with dissolved pollutants to roots of one or more plants supported by a biowall; and
metabolizing at least a portion of the dissolved pollutants supplied to the roots.

2. The method of claim 1, wherein the one or more pollutants comprise one or more volatile organic compounds (VOCs).

3. The method of claim 2, wherein the VOCs include at least one of formaldehyde, benzene, xylene, toluene, ethylbenzene, and polycyclic aromatic hydrocarbon.

4. The method of claim 2, wherein the metabolizing is performed, at least in part, by bacteria at the roots of the one or more plants.

5. The method of claim 4, wherein the bacteria are from the Hyphomicrobium genus or the Pseudomonas genus.

6. The method of claim 5, wherein the bacteria comprise Hyphomicrobium denitrificans or Pseudomonas putida G7.

7. The method of claim 1, wherein the dissolving comprises bubbling air with pollutants through the solution.

8. The method of claim 7, wherein the bubbling air comprises passing air from the environment through a porous material so as to generate bubbles in the solution.

9. The method of claim 1, wherein the dissolving is performed before the solution is supplied to the roots.

10. The method of claim 1, wherein the solution comprises water supplemented with nutrients for plant growth.

11. The method of claim 1, wherein the supplying the solution to the roots is via a hydroponic irrigation system or an aeroponic irrigation system of the biowall.

12. The method of claim 1, wherein the environment comprises an interior of a building or other inhabitable structure, and the biowall is installed in the environment so as to operate independent of a heating/ventilation/air-conditioning (HVAC) system of the building or other inhabitable structure.

13. A biowall comprising:
a support structure constructed to hold a plurality of plants thereon;
an irrigation system constructed to supply a solution to roots of the plants held by the support structure; and
a dissolution system constructed to dissolve one or more pollutants from air into the solution.

14. The biowall of claim 13, wherein the roots of the plants have bacteria that metabolize at least a portion of the pollutants dissolved in the solution.

15. The biowall of claim 14, wherein the one or more pollutants comprise one or more volatile organic compounds (VOCs).

16. The biowall of claim 15, wherein the VOCs include at least one of formaldehyde, benzene, xylene, toluene, ethylbenzene, and polycyclic aromatic hydrocarbon.

17. The biowall of claim 14, wherein the bacteria are from the Hyphomicrobium genus or the Pseudomonas genus.

18. The biowall of claim 17, wherein the bacteria comprise Hyphomicrobium denitrificans or Pseudomonas putida G7.

19. The biowall of claim 13, wherein the irrigation system comprises a reservoir, and the dissolution system is constructed to dissolve the one or more pollutants in solution from the reservoir prior to being supplied to the plurality of plants.

20. The biowall of claim 13, wherein the dissolution system comprises a gas-absorption bubbling fluid column that generates bubbles of air in the solution to dissolve the one or more pollutants in the solution.

21. The biowall of claim 13, wherein the dissolution system comprises an aerator or a porous material through which air is passed so as to generate the bubbles.

22. The biowall of claim 13, wherein the support structure extends substantially vertically with respect to gravity, and the irrigation system employs, at least in part, gravity and/or capillary action to supply the solution, with the one or more pollutants dissolved therein, to the roots.

23. The biowall of claim 13, wherein the irrigation system is aeroponic or hydroponic.

24. The biowall of claim 13, wherein the biowall is constructed as a self-supporting, stand-alone unit.
